(19) United States
(12) Patent Application Publication
(10) Pub. No.: US 2004/0063082 A1
(43) Pub. Date: Apr. 1, 2004

(54) Behavior change tool

(76) Inventor: Michael O'Donnell, West Bloomfield, MI (US)

Correspondence Address: CLARK & ELBING LLP, 101 FEDERAL STREET, BOSTON, MA, 02110, US

(21) Appl. No.: 10/391,976

(22) Filed: Mar. 19, 2003

Related U.S. Application Data
(63) Continuation of application No. 09/901,852, filed on Jul. 9, 2001, now abandoned.

(51) Int. Cl. G06F 17/60; G09B 19/00

(52) U.S. Cl. 434/238; 705/14

(57) ABSTRACT

Method for assisting a person in changing a behavior, e.g., smoking, by employing multiple steps, including e.g., having the person assess, quantitatively, the degree of readiness to change, having the person assess, quantitatively, the difficulty of changing a given behavior, having the person list benefits and obstacles involved in changing the behavior, and devising a strategy for changing the behavior, that includes positive reinforcement and self-efficacy.

### CROSS REFERENCE TO RELATED APPLICATIONS

This application is a continuation of U.S. Ser. No. 09/901,852, filed Jul. 9, 2001.

### BACKGROUND OF THE INVENTION

Changing self-destructive behaviors such as overeating, smoking and living a sedentary lifestyle is notoriously difficult.

### SUMMARY OF THE INVENTION

The invention features, in a first aspect, a method for assisting a person in changing a behavior, e.g., smoking, by the following steps: a) having the person assess, on a quantitative scale, the degree of his readiness to change; b) having the person assess, on a quantitative scale, the difficulty of changing said behavior; c) having the person list the benefits he perceives would accrue as a result of changing the behavior; d) having the person list the obstacles he perceives would impede changing the behavior; e) devising a strategy for changing the behavior, including positive re-enforcement and self-efficacy (discussed below); and f) implementing the strategy. Preferably, after step c), the person ranks the perceived benefits of changing in order of importance.

The invention also features, in a second aspect, a method for assisting a person with multiple behaviors he wishes to change prioritize those behaviors to identify one or more of them to worked on before the others. The method involves the steps of a) having the person rank his relative readiness to change the multiple behaviors, b) having the person assess, on a quantitative scale, the social pressure to change each behavior, c) having the person record his personal history surrounding each behavior, and d) on the basis of (a)-(c), determining which behavior or behaviors are to be worked on first. The method can further include, prior to step (d), the steps of (e) having the person rank the relative importance of changing each behavior, and (f) having the person rank the relative difficulty of changing each behavior, wherein step (d) takes into account steps (e) and (f).

The methods of the first and second aspects of the invention, assisting in changing behavior and identifying behaviors to attempt to change ahead of others, can be combined in many ways. The 25 steps described in detail below, some of which assist behavior change and some of which assist prioritization of behaviors to work on, can be combined in any multi-step process that is novel and useful. For example, before carrying out the method of the first aspect of the invention, a prioritization process can be carried out. Preferably, this involves the steps of: i) having the person rank his relative readiness to change multiple behaviors that potentially need to be changed; ii) having the person rank the relative importance of changing the multiple behaviors; iii) having the person rank the relative difficulty of changing the multiple behaviors; and iv) on the basis of the rankings of i)-iii), prioritizing the behaviors to work on changing, thereby selecting the first of the behaviors to work on changing.

Other features and advantages of the invention will be apparent from the following detailed description, and from the claims.

### DETAILED DESCRIPTION

In one embodiment, the invention utilizes a 25 step process which utilizes several important psychological principles. The steps, psychological principles, measurement tools, and sample scoring protocol are described below. A sample questionnaire is attached.

Stage 1: Preliminary Assessment of Likelihood of Success

Step 1: Identify Health Behaviors to be Changed

In the first step, the user lists the health behaviors or related health conditions he or she is considering changing. These may have emerged from a health screening, a health risk appraisal, comments from a health care professional or friends, or through self-reflection. Printed versions of the questionnaire can include lists of health behaviors or conditions which can be checked off. Computer based versions will always include a list which can be checked off. A sample list is shown below.

exercise more regularly

quit smoking

eat more nutritious foods

manage stress more effectively

lose weight or maintain existing weight

quit or reduce alcohol consumption

quit or reduce use of marijuana or other drugs

improve dental hygiene

enhance spiritual health

enhance quality of social relationships

enhance intellectual challenges

improve compliance in taking prescribed medication

Step 2: Clarify Your Readiness to Change Each Behavior

The second step is to rank the person's current stage of readiness to change each of the behaviors. The stages of change concept is drawn from the Transtheoretical model developed by James Prochaska and Carlos Diclement (1986). This concept recognizes that a person is at different stages of readiness to change each of multiple behaviors that potentially need changing. There are five basic stages. People who are not even thinking about making a particular behavior change are in “precontemplation.” People who are not ready to change now but might be ready in the next 6 months are in “contemplation.” People who are getting ready to make the change in the next month are in “preparation.” People who are have made the change, but only recently, are in “action.” People who have been practicing the behavior change on a regular basis for six months or more are in “maintenance.”

Readiness to change is measured by the attached questionnaire. The user completes this questionnaire for each behavior under consideration. In the paper and pencil version, if more than 5 behaviors or conditions are being considered, an expanded questionnaire will be required. In the computer version, this will be handled automatically. Based on these responses, each behavior is scored on a 1 to 5 bases, with maintenance equaling 5 and pre-contemplation equaling 1.

Step 3: Rate How Important You Feel it is to Change Each Behavior

In the third step, the user determines how important they feel it is for them to change each behavior from four perspectives: health impact, quality of life impact, social impact and financial impact. Importance is measured by the attached questionnaire. Importance is rated on a 1-4 Likert-type scale for each behavior from each perspective. The score for this section is determined by adding all the circled numbers and dividing by three. In the paper and pencil version, the user does this manually. In the computer version, this is calculated automatically.

Step 4: Rate How Difficult You Feel it is to Change Each Behavior

In step 4, the user determines how difficult he or she thinks it will be to change each behavior. Difficulty is rated on a 1-4 Likert type scale.

Step 5: Measuring Social Pressure and Motivation to Follow Social Pressures

In step 5, the social pressures felt by the user to practice the behaviors being considered are measured, as well as the user's desire to comply with those pressures. These pressures and desire to comply are measured for close friends, co-workers, spouse, significant other or partner, other family members, and a physician or health care provider. These concepts are drawn from the Theory of Reasoned Action developed by Fishbein and Aizen.

Scores are determined for each behavior by multiplying the score (1-4) for each person's beliefs about the behavior times the score (1-4) for the user's desire to comply with those behaviors. These scores will range from 1 to 16. The total scores for each person are then added up for each behavior. These will range from 5 to 80. These raw scores are then converted to scores for the process using the rating scale below.

Rating Scale: 0-40: 1 (Virtually no Social Pressure)

41-60: 2 (small social pressure)

61-70: 3 (some social pressure)

71-80: 4 (strong social pressure)

In the printed version, the user will do the math and compiling required to determine these scores manually. In the computer version, the math and compiling will be done automatically.

Step 6: Recording Your Personal History

In step 6, the user's personal history will be measured for each behavior being considered. The likelihood of practicing each behavior in the past will influence the likelihood of successfully adopting the behavior in the future. The level of past experience for each behavior is rated on a scale from 1 to 4.

Step 7: Preliminary Perspective on Readiness, Importance and Difficulty, Social Pressure, and Past Experience

The scores in steps 2-6 are used to develop a preliminary set of behavioral priorities. In simple terms, behaviors or conditions the user feels he or she is ready to change, are important to change, will be easy to change, are encouraged to change by important others and have been part of the user's life in the past are the best candidates for change. Among those, the behaviors which have the highest total score are the strongest candidates, and those with the lowest scores are the weakest candidates. Conversely, behaviors or conditions the user feels he or she is not ready to change, or are not important to change, will not be easy to change, are not encouraged by important others and are completely new behaviors, are the worst candidates for change. The remaining behaviors will probably be difficult to change but may be attempted if no behaviors fall into the first set of strongest candidate behaviors. Within this final group, those with the highest scores are the best candidates for change.

Total scoring for the first five analysis steps uses the protocol below. In the printed version, users will do the scoring manually. In the computer version, it will be calculated automatically.

Success very likely: Score of 3 or higher on each of the five scales, AND total score of 17 or higher.

Success likely: Score of 3 or higher on at least four of the five scales, OR total score of 14-16.

Success possible: Score of 3 or higher on at three of the five scales, and total score 10 or higher.

Success unlikely: Score of 2 or lower on at least three scales OR total score 9 or lower.

Step 8: Preliminary List of Target Behaviors, Short and Long Term Goals

In step 8, the user lists all of the behaviors in decreasing order or the total score, and within each of the four success categories. This provides a tentative list of the order in which behavior changes should be attempted. The user is encouraged to select one or two behaviors to focus on initially and told to consider other behaviors after those first two are successfully changed. Long term and short term goals are written for those behaviors. Listing the long-term goal defines what the user is ultimately trying to achieve. Listing short-term goals provides an immediate focus for efforts for goals that can be achieved in the near future. For example, if the user wants to lose weight, the long-term goal might be to reach the recommended weight for his or her height and frame. This weight would be stated. The short-term goals might be to develop an exercise program and a nutritious diet program within the next two weeks.

This is the end of the first stage. Users have a good sense of the health behaviors or conditions they are most likely to successfully change, and a statement of long-term and short-term goals for each behavior. Some users of the Health Behavior Change Planning Tool may choose to stop at this point.

Stage 2: Improving Likelihood of Success Scores

The second stage is designed to explain the types of lifestyle changes required to successfully make a health behavior change and to increase the chances of success.

A person will be motivated to change a behavior if he or she believes that change will produce a desired benefit. For example, a person might be motivated to quit smoking because he or she wants to reduce his or her likelihood of getting lung cancer. He or she will be motivated to quit smoking based on how important it is for him or her to avoid lung cancer and the extent to which he or she believes quitting smoking will help him or her avoid lung cancer. This is called outcome efficacy and is drawn from Social Cognitive Theory (Bandura). The next three steps help the user articulate the benefits important to him or her, rate the perceived outcome efficacy of these benefits, and think about how the outcome efficacy might be enhanced.

Step 9: Review Benefits

In step 9, the user lists the benefits he or she expects to receive as a result of the behavior changes being considered. Benefits will be considered under two main categories: health, and non-health benefits, including quality of life and social and financial benefits. The written questionnaire version will include a list of benefits commonly listed for each behavior in each category. The user can rewrite these on the questionnaire, circle them on the list, refer to them by number on the questionnaire, summarize them, or record them using whatever other method is desired. The computer version will provide a similar list. The user will “click” on the benefits more relevant to him or her. The user will then select the top five health and non-health benefits for each behavior and rate the importance of each benefit on a Likert type scale.

If the user is working with a counselor or is interested in learning more about the benefits of each of the behaviors being considered, this optional educational step can be added at this point.

Step 10: Rating the Importance of Benefits

After the benefits are listed, the user rates the importance of each of these benefits for himself or herself. The scores for each behavior are then totaled by adding the circled numbers and dividing by the number of benefits listed. In the example, 10 benefits are listed, so the total is divided by 10. Each behavior is scored on perceived benefits using the protocols below.

Strong perceived benefits: 3.56 to 4.0

Moderate perceived benefits: 3.0 to 3.55

Weak perceived benefits: less than 3.0

Any behaviors with weak perceived benefits are no longer considered. The further analysis is conducted only for behaviors with strong or moderate perceived benefits.

Step 11: Measuring Outcome Efficacy

Outcome efficacy is the user's perception of how likely changing each behavior will help the user achieve each of the benefits listed. Outcome efficacy is measured for each behavior still being considered (each behavior with moderate or strong benefits ratings) by asking the user how likely he or she will achieve each of the benefits listed in step 9, if the behavior change is successfully achieved. Likelihood is rated using a 4 point Likert-type scale with ratings from very likely to very unlikely. The final score is determined by adding all the circled numbers and dividing the sum by the number of benefits listed. The example shows 5 health and 5 non-health benefits.

Step 12: Enhancing Outcome Efficacy

If the user is working with a counselor, in the context of a structured program, or has access to educational materials, this is an important educational opportunity for the user to learn about the benefits of changing various health behaviors. This is especially important when the user rates the changing of all of his or her deleterious health behaviors as having weak perceived benefits.

The goal of this referral or instruction is to help the user get an accurate sense of the likely outcome of making the behavior change. For example, if the user is not confident that quitting smoking will decrease his or her chances of getting lung cancer, educational efforts can help him or her understand that it will.

This step can be skipped if these resources are not available to the user.

Step 13: Prioritizing Behaviors Based on Importance

Behaviors still under consideration are prioritized based on outcome efficacy by multiplying the benefits importance ratings in step 10 for each benefit by the likelihood scores in step 11. Scores for each behavior are totaled and divided by the number of benefits listed for each behavior. Behaviors are then organized numerically by decreasing score. Each behavior is then categorized using the scoring key below.

Most important: 14-16

Very important: 12-13.9

Somewhat important: 9-11.9

Not important: 0-8.9

Decreasing Perceived Obstacles

If a person believes there are significant obstacles which will prevent him or her from successfully changing a behavior, it is very unlikely he or she will successfully change those behaviors, even when the obstacles are perceived rather than actual. Strategies to reduce perceived obstacles are employed for each of the behaviors rated “most important” or “very important” or “somewhat important” in step 13.

Step 14: Recognizing Obstacles

The user is asked what obstacles he or she expects to encounter in changing each of the health behaviors being considered. These are written directly on the printed version, or typed into the computer version. Users can be prompted with lists of typical obstacles in the print or computer versions. Obstacles are different for each behavior and for each person, but most fit into a number of major categories, including insufficient time, embarrassment, opposition from family and friends, poor access to facilities, etc. Low Self efficacy, or lack of confidence that a behavior can be performed consistently, is a special class of obstacle, and is discussed in the next step.

After all the obstacles are listed for each behavior, the user is asked to rate each obstacle on a four point Likert-type scale.

Step 15: Estimating Self Efficacy

Self efficacy is the extent to which a person believes he or she can practice a specific behavior (Bandura). The greater the self efficacy, the more likely the person will be successful in changing the behavior. Self efficacy will be measured for each of the behaviors rated “most important” or “very important” or “somewhat important” in step 13.

In the print version, self efficacy can be measured using the standard questions provided. In the computer version, the standard questionnaires can be used or a custom questionnaire can be developed based on the user's specific comments.

The custom questionnaire is developed by asking the user to type in the biggest challenges they will face in making each behavior change. For example, the user would be asked, “When will it be most difficult for you to continue not smoking.?” The user might respond: “If other people offer me a cigarette,” or “When I am feeling stressed,” or “After a meal.” Those responses are then plugged into the self efficacy questionnaire and scored the same way as the standard questionnaire, using the scoring protocol below. Typical responses that might be listed by the user are shown on the attached questionnaire; these can serve as the standard questionnaire.

High self efficacy: 3.6-4.0

Moderate self efficacy: 3.0-3.5

Low self efficacy: less than 3.0

Step 16: Enhancing Self Efficacy

The user devises strategies to overcome the obstacles identified, thus enhancing his or her self efficacy and increasing the likelihood of successfully changing the target behavior.

Self efficacy can be enhanced four ways.

The most effective method is called “enactive mastery experience” or “practice,” in which the person successfully practices the desired behavior, even on a trial basis. For example if getting regular exercise through walking is the desired behavior, and the user likes art, he or she can make a commitment to go to a large nearby museum and walk through the museum for a set period of time. When the person realizes that strolling through the museum has involved walking for an extended period, this enhances his or her self efficacy, or confidence, that he or she can do the walking that is required in an exercise program. Similar walking plans can be made for site seeing, shopping, hiking, etc. Similar strategies can be used for other behaviors. Some users may be able to develop strategies on their own, but a counselor or coach can be very important at this stage. Some users may also be able to draw ideas from books and other sources.

The next most effective method is called “vicarious experience” or “watching.” In this method, the user observes or thinks about someone who has successfully made a similar behavior change, or is in the process of doing so. Seeing that someone else has been successful helps the user believe he or she can also be successful. This is most effective if the user can relate to the person being observed. A counselor can help at this stage by making the user aware of such people.

The next most effective method is called “verbal persuasion” or “coaching.” In this method, a counselor, teacher, physician or respected peer tells the user that he or she has confidence that the user can successfully make the behavior change in question. Some people can provide this coaching for themselves, but not many. A coach, teacher or someone else is very important for this method.

The final method is understanding, reframing and managing physiological and emotional reactions to change. For example, if someone starts to exercise, it is very common for the first attempt to be exhausting. If someone quits smoking, it is very common to feel the disturbing physical symptoms of withdrawal. If someone is reducing their calorie consumption, it is common to have hunger pangs, be irritable, etc. If the person does not understand that these feelings are a natural part of the change process, he or she is likely to do what ever is necessary to avoid these feelings, and that normally means reverting to the old behavior. However, if the user knows in advance that these reactions are a natural part of the change process, and in fact are an important step toward success, he or she can withstand them better. If the user is also taught relaxation techniques, or other ways to manage these behaviors, he or she will be even more successful. Users can be referred to educational materials, or can work with a counselor for this method.

If the user is working with a counselor, the counselor can help the user develop solutions. Alternatively, the user can be referred to other educational materials for ideas. If neither of these is available, the user can devise his or her own solutions.

In the print version, solutions are written directly on the questionnaire. In the computer version, solutions are typed into the computer.

Step 17: Developing Strategies to Overcome Obstacles

In this step, the user develops strategies for all obstacles rated “major” or “moderate” barriers. In the print version, these are written directly on the questionnaire. In the computer version, they are typed in the computer.

Some users can complete this step on their own, but a counselor will be very helpful at this step. If a counselor is not available, the user can be referred to educational materials.

The final part of step 17 is to rate the effectiveness of the strategies developed to overcome each of the barriers using the questionnaire. Step 17 should be repeated until each of the strategies is rated at least “moderate.”

Stage 3: Developing a Behavior Change Plan

The third stage in the process is developing a behavior change plan to maximize successful behavior change. This stage involves six steps.

Step 18: Determining Technical Knowledge or Expert Advice Required

In step 18, the user is asked to list the technical knowledge or expert advice that will be helpful in successfully implementing the plan. This knowledge and expertise can be provided by counselors, educational programs, educational materials, and other sources.

In the print version, answers are written directly on the questionnaire. In the computer version, they are typed into the computer.

Step 19: Creating A Supportive Environment

In step 19, the user is asked to describe how he or she will make changes in his or her home, office and other settings to make the old behavior more difficult to practice and the new behavior easier to practice. For example, if the person is trying to eat a more healthful diet, he or she might plan to dispose of all candy in his or her house and keep plenty of fresh fruits available for snacks. He or she might plan to eat only in restaurants that serve healthful foods in reasonable portion sizes. Discussing ideas with friends who have made similar changes in their lives can be very helpful in this process. A counselor or teacher can also be very helpful.

In the print version, these are written directly on the questionnaire. In the computer version, they are typed into the computer.

Step 20: Rewards and Celebrations

In step 20, the user is asked if rewards or celebrations are important in helping him or her work harder to practice the new behavior. If the user says “Yes,” he or she is encouraged to identify rewards or celebrations he or she will value for short term and long term goals. Rewards and celebrations must be consistent with the new behavior. For example, if the user is trying to lose weight and likes new clothes, a good reward for losing 10 pounds might be to purchase a new skirt in a smaller size. Having a hot fudge sundae would be a self-defeating reward. If the user is trying to improve fitness through running, participating in a local fun run might be a good celebration.

In the print version, these are written directly on the questionnaire. In the computer version, they are typed into the computer.

Step 21: Build Behaviors Into Your Routine

In step 21, the user is asked how the new behavior will be built into his or her routine. This is critically important because the chances of success are very low if the user has to discipline him or herself to practice the new behavior. If it is part of the routine of everyday life, it will be much easier to practice. For example, if the user is trying to exercise at least three days a week and does not build the exercise into his or her schedule, success is unlikely. However, if he or she budgets time to exercise every other day before work, success is much more likely.

In the print version, these are written directly on the questionnaire. In the computer version, they are typed into the computer.

Step 22: Build a Social Support Network

In step 22, the user is asked to identify friends and family members who will provide support in helping the user practice the new behavior, and the type of support those people will provide. The stronger the support network for the new behavior, the greater the likelihood of success, especially for users who are dependent on friends and family. For example, if a married woman is trying to eat healthful food and her husband is in charge of shopping and cooking, it will be very important that the husband makes a commitment to buy and prepare only healthful foods. If man is planning to increase exercise through swimming, it may be very helpful to have a group of friends to swim with, perhaps even in a master's swim program.

In the print version, these are written directly on the questionnaire. In the computer version, they are typed into the computer.

Step 23: Make a Commitment to a Friend

If the user has some important friends or family members who are especially interested in the person making the behavior changes, or who will agree to provide special forms of support, a Contract for Behavior Change can be signed with each of these people. The specific support provided by the friend or family member will be written into the contract.

In the print version, three copies of the Contract will be provided. In the computer version, the details will be typed into the computer, and printed out for the support person to sign.

Stage 4: Making Final Plans and Identifying Milestones

Step 24: Summarize Plans and Identify Milestones

In stage four, the user reviews all the plans that have been made in steps 18-23 and summarizes what behaviors changes will be made, when they will be made, and the support features most critical to the behavior change. For example, the user might say he or she will exercise at least 30 minutes per day, swimming 3 days a week, doing aerobics 2 days per week and walking 2 days per week. Swimming will be done in a master's swimming program at the local community pool at 6:00 am Monday and Wednesday, and at 8:00 am on Saturday. Aerobics will be at 5:30 pm on Thursday and Tuesday and walking will be done in the neighborhood with neighbors on Tuesday at 5:30 pm and Sunday at 9:00 am. The walking program will start in one week, the swimming will be added in three weeks, and the aerobics will be added in 5 weeks.

In the print version, the user will be referred back to the relevant steps in the questionnaire. In the computer version, these steps will be presented to the user automatically.

Stage 5: Monitoring Progress

Step 25: Monitoring Progress

In step 25 five, progress will be monitored based on the goals set in stages 2, 3 and 4.

Progress in achieving the goals will be monitored at the end of the first, second, and 4th weeks, and the 2nd month and then quarterly. Success in reaching goals will be determined at each monitoring stage. If goals are not achieved, strategies will be redeveloped and new goals set.

A counselor can be very helpful in this final stage.

What is claimed:

1. A method for assisting a person in changing a behavior, said method comprising the steps of:
a) having the person assess, on a quantitative scale, the degree of his readiness to change,
b) having the person assess, on a quantitative scale, the difficulty of changing said behavior,
c) having the person list the benefits he perceives would accrue as a result of changing said behavior,
d) having the person list the obstacles he perceives would impede changing said behavior,
e) devising a strategy for changing said behavior, including positive re-enforcement and self-efficacy, taking into account the assessments of (a)-(d), and
f) implementing the strategy of (e).

2. The method of claim 1, further comprising having the person rank the perceived benefits of (c) by importance.

3. The method of claim 1, wherein the person has multiple behaviors he wishes to change, and wherein said method further comprises, prior to step (a), prioritizing the behaviors potentially to be changed, by the steps of:
i) having the person rank his relative readiness to change said multiple behaviors,
ii) having the person rank the relative importance of changing said multiple behaviors,
iii) having the person rank the relative difficulty of changing said multiple behaviors, and
iv) on the basis of the rankings of i)-iii), prioritizing the behaviors to work on changing, thereby selecting the first said behavior to work on changing.

4. The method of claim 1, wherein said strategy includes providing an environment which is supportive of changing said behavior, said supportive environment including a social support network.

5. A method for assisting a person with multiple behaviors he wishes to change prioritize said behaviors to identify one or more behaviors to be worked on before the others, said method comprising the steps of
a) having the person rank his relative readiness to change said multiple behaviors,
b) having the person assess, on a quantitative scale, the social pressure to change each behavior,
c) having the person record his personal history surrounding each behavior, and
d) on the basis of (a)-(c), determining which behavior or behaviors are to be worked on first.

6. The method of claim 5, further comprising, prior to step (d), the steps of (e) having the person rank the relative importance of changing each behavior, and (f) having the person rank the relative difficulty of changing each behavior, wherein step (d) takes into account steps (e) and (f).
